(19) United States
(12) Patent Application Publication
(10) Pub. No.: US 2006/0112740 A1
(43) Pub. Date: Jun. 1, 2006

(54) Security device including engagement member

(75) Inventors: Ralph Merrem, San Francisco, CA (US); Steve Gelphman, Half Moon Bay, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Acco Brands, Inc., Lincolnshire, IL (US)

(21) Appl. No.: 11/000,397

(22) Filed: Nov. 29, 2004

(51) Int. Cl. E05B 73/00

(52) U.S. Cl. 70/58

(57) ABSTRACT

A security device for use with a security aperture is disclosed. The security device includes an engagement member capable of being in a locked position or an unlocked position, a spacer, a locking mechanism adapted to maintain the locked position of the engagement member, and a housing disposed around the locking mechanism, where the housing is adapted to rotate substantially independently of the engagement member when the spacer is in the locked position.

### BACKGROUND OF THE INVENTION

The theft of electronic devices such as computers, cell phones, and flat panel TVs is a significant problem. A variety of security devices have been developed to inhibit the theft of such devices. A typical security device includes a rigid portion that can be inserted into a slot in a wall of a housing of an electronic device. The security device can secure the electronic device to an immovable object such as a desk to inhibit theft of the electronic device.

While such security devices are effective, a number of improvements could be made. For example, since the security device and the wall of the housing are both rigid, a thief may try and apply a torque to the security device to thereby “twist” the rigid portion of the security device out of the security slot. This may eventually damage the housing of the electronic device and may therefore deter the thief from trying to separate the security device from the portable electronic device in the first place. However, the security device can be separated from the electronic device nonetheless.

It would also be desirable to provide for a security device that addresses the above problem. It would also be desirable to solve the above problem and other problems in a cost effective manner.

Embodiments of the invention address the above-noted problem and other problems, individually and collectively.

### SUMMARY OF THE INVENTION

Embodiments of the invention are directed to security devices, security systems, and methods for using security devices.

One embodiment of the invention is directed to a security device for use with a security aperture, the security device comprising: an engagement member capable of being in a locked position or an unlocked position; a spacer adjacent to the engagement member; a locking mechanism adapted to maintain the locked position of the actuating element; and a housing disposed around the locking mechanism, wherein the housing is adapted to rotate independently of the spacer when the engagement member is in the locked position.

Another embodiment of the invention is directed to a security device for use with a security aperture, the security device comprising: a compressing element capable of being in a locked position and an unlocked position; a compressible engagement member; and a locking mechanism adapted to maintain the locked position of the compressing element, wherein the compressible engagement member is compressed by the compressing element when the compressing element is in the locked position, and wherein the compressed compressible engagement member prevents removal of the compressible engagement member from the security aperture.

Another embodiment of the invention is directed to a security system comprising: an article comprising a security aperture; and a security device for use with a security aperture, the security device comprising a compressing element capable of being in a locked position and an unlocked position, a compressible engagement member, and a locking mechanism adapted to maintain the locked position of the compressing element, wherein the compressible engagement member is compressed by the compressing element when the compressing element is in the locked position, and wherein the compressed compressible engagement member prevents removal of the compressible engagement member from the security aperture.

Another embodiment of the invention is directed to a method for securing an article, the method comprising: obtaining an article comprising a security aperture; inserting a compressing element and a compressible engagement member in a security device into the security aperture; compressing the compressible engagement member using the compressing element; and maintaining a locked state of the compressing element.

These and other embodiments of the invention will be described in further detail below.

### BRIEF DESCRIPTION OF THE DRAWINGS

FIG. 1 shows a perspective view of a security device according to an embodiment of the invention.

FIG. 2 shows an exploded view of the security device shown in FIG. 1.

FIG. 3 shows a side view of a portion of the security device disposed in a security aperture of a housing of an article.

FIG. 4 shows a perspective view of a compressing element and pins extending from the compressing element.

It is understood that positional terms such as “rear” and “front” are with reference to the embodiments shown in the Figures and such terms may or may not describe the absolute positions of various components of embodiments of the invention.

### DETAILED DESCRIPTION

Embodiments of the invention are directed to security devices, security systems, and methods for using security devices.

In one embodiment, the security device is used with a security aperture. The security aperture may be formed in a housing of an article to be secured, or it may be formed in a bracket or other structure that is to be secured to the article. Using the security device, the article can be secured to an immovable object such as a desk. The security device may also include a security body such as a cable. The cable may be wrapped around the immovable object to localize the article with respect to the immovable object.

Preferably, the security aperture is in the form of a security slot that is formed in the housing of the article. For example, the security slot may have dimensions of about 3 mm by about 7 mm. Providing a security slot in a housing of an article such as a portable electronic device is desirable, since any attempt to separate the security device from the article will likely result in damage to the article. This deters potential thieves from ever attempting to separate the security device from the article.

In some embodiments, the security device comprises an engagement member that is capable of being in a locked position or an unlocked position, and a locking mechanism adapted to maintain the locked position of the engagement member. A housing can be disposed around the locking mechanism. The housing may rotate generally independently of the spacer and the engagement member when the engagement member is in the locked position. For example, the spacer and the engagement member can be substantially stationary (e.g., stationary) while the housing rotates counterclockwise. As used herein, “rotates substantially independently” can include movement of the engagement member that is due to frictional forces. For example, turning the housing may cause the engagement member to turn, but to a lesser degree than the housing. The turning of the engagement member in this case would be due to frictional forces present between the housing of the security device, the engagement member, and the housing wall of the article to be secured.

In preferred embodiments, the engagement member is a compressible engagement member and is formed from a compressible material. The compressible engagement member is in an uncompressed state when the security device is in an unlocked state. When the security device is in a locked state, the compressible engagement member is in a compressed state. A compressing element may be used to compress the compressible engagement member against a wall, which includes the security aperture. In the compressed state, the lateral dimensions of the compressed engagement member are increased so that they are larger than the dimensions of the security aperture. This prevents the engagement member from being removed from within the security aperture, and thus prevents the security device from being separated from the article to which it is attached.

In embodiments of the invention, an elongated member such as a rod, which can rotate about its axis, is coupled to the housing and may pass through the engagement member and a spacer adjacent to the engagement member. The housing of the security-device and elongated member may move relative to the spacer and the engagement member. Since the elongated member is not rigidly coupled to the spacer and the engagement member, the elongated member “floats” with respect to the spacer and the engagement member. In other embodiments, the elongated member may be rigidly connected to the engagement member and may float with respect to the spacer. Advantageously, a thief trying to torque the housing to separate the security device from the article will find that the housing will simply turn relative to the engagement member. The torque cannot be used to separate the security device from the article, since the elongated member is not rigidly coupled to the spacer and the engagement member. This is described in further detail below.

Any suitable article may be secured using the security device. Suitable articles include portable electronic devices such as computers (e.g., laptop computers), displays (e.g., flat panel displays including flat panel television sets), cell phones, personal digital assistants, printers, radios, MP3 players, DVD players, etc. The articles to be secured may also include non-electronic articles such as bicycles.

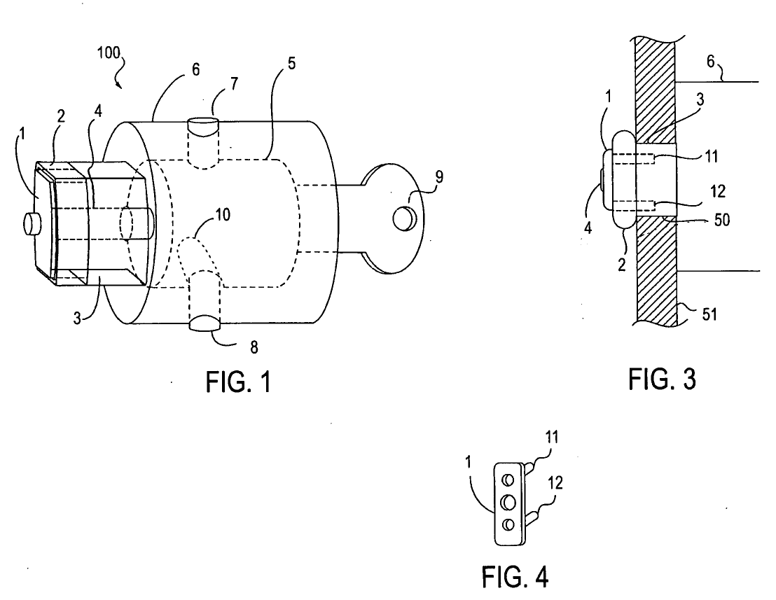

FIGS. 1 and 2 show a security device 100 according to an embodiment of the invention in an unlocked state. The security device 100 includes a front portion with a compressing element 1, a compressible engagement member 2, and a spacer 3. The width of spacer 3 can be substantially equal to or greater than the maximum housing thickness. For example, the length of the spacer 3 can be about 4.0 mm if the wall thickness of the housing is also about 4.0 mm. In this example, the spacer 3 is generally rectangular so that it passes through a generally rectangular security slot in a housing of an article. The spacer 3 can be made of any suitable material including a rigid metal or plastic.

In the illustrated embodiment, an elongated member 4 passes though the spacer 3 and the compressible engagement member 2. The elongated member 4 may pass through and/or be coupled to the compressing element 1. While the compressing element 1 is in the form of a plate in this example, the compressing element 1 can be in any other suitable form in other embodiments.

The compressing element 1 may be coupled to the elongated member 4 in any suitable manner. For example, the compressing element 1 may be coupled to the elongated member 4 with a pin, weld, or bolt. Alternatively, the compressing element 1 may be integrally formed with the elongated member 4. Although FIG. 1 shows the elongated member 4 passing through and “floating” with respect to the compressible engagement member 2, it need not be as long as the elongated member 2 “floats” with respect to the spacer 3. Although the spacer 3 and the compressible member 2 are shown as being separate, they could be integral and/or rigidly connected together.

The compressible engagement member 2 may have any suitable shape. For example, the compressible engagement member 2 may be in the form of a rectangular block with a hole in it. It could alternatively be in the form of a disk, or an elastic ring. It may also have any suitable thickness.

The compressible engagement member 2 may also be made of any suitable material. In embodiments of the invention, the compressible engagement member 2 may be made from an elastomeric material, or a compressible foam material. Exemplary elastomeric materials include rubber.

A rear portion of the security device 100 has a housing 6, which houses a lock mechanism (not shown). A key 9 may interact with the lock mechanism. A cylinder 5 is inside of the housing 6 and is coupled to the elongated member 4. The cylinder 5 includes one or more grooves 10, which may spirally shaped. One or more pins 7 and 8 may fit in the grooves 10 and may be coupled to the housing 6.

The housing 6 may be made of any suitable material and may have any suitable configuration. For example, the housing 6 may be cylindrically shaped, or may have a somewhat flat, oblong configuration. Suitable materials for the housing 6 may include strong materials such as stainless steel or nickel alloys.

The lock mechanism that is present in the cylinder 5 may be any suitable type of lock mechanism. Exemplary lock mechanisms include tubular lock mechanisms, combination lock mechanisms, and ordinary pin and tumbler lock mechanisms. Suitable lock mechanisms are described in U.S. Pat. No. 6,000,251 and U.S. patent application Ser. No. 10/970,060, filed on Oct. 20, 2004, which are herein incorporated by reference in their entirety for all purposes. As shown in FIG. 1, a key 9 can be used to put the security device 100 and any of the components in the security device 100 in a locked or an unlocked state.

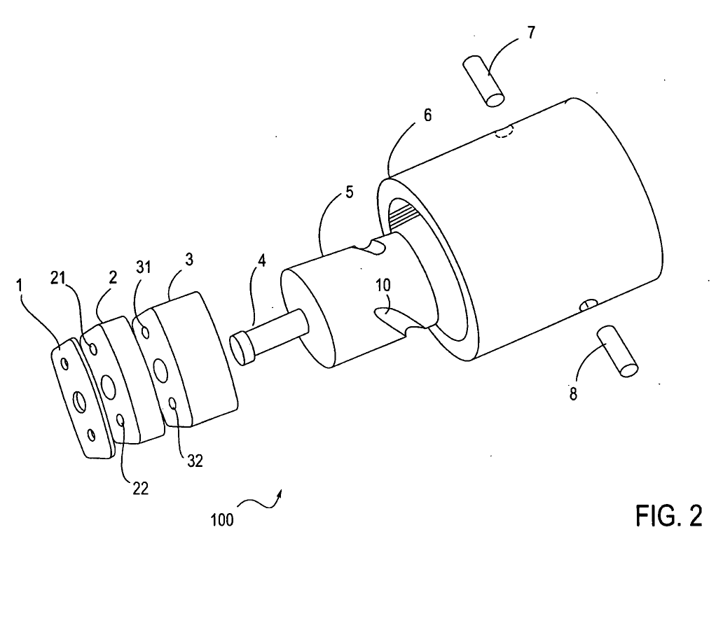

Referring to FIGS. 3 and 4, the elongated member passes through holes in the compressing element 1, the compressible engagement member 2, and the spacer 3. Pins 11, 12 may pass through the compressible engagement member 2 and may couple the spacer 3 and the compressing element 1 together. The pins 11, 12 can pass through holes 21, 22 in the compressible member 2 and holes 31, 32 in the spacer 3 to join the compressing element 1 and the spacer 3 together.

The use of the security device 100 can now be described with reference to FIGS. 1-4.

FIG. 1 shows the lock in the unlocked state. The elongated member 4 is attached to the compressing element 1, which is in the form of a rectangular (slot shaped) plate in this example. In other embodiments, the compressing element 1 could be in the form of a ball, ring, or other structure suitable for compressing the compressing element 1. As shown in FIG. 3, the compressing element 1 and the compressible engagement member 2 are inserted into the security aperture 50 in the wall of a housing 51 of an article.

The security device 100 is then put into a locked state. The key 9 is then turned clockwise (or counterclockwise, depending on the type of locking mechanism) to put the security device 100 into a locked state. As the key 9 turns, the cylinder 5 turns along with the key 9. The pins 7, 8 that are in the grooves 10 then follow the grooves 10 during the turning of the cylinder 5. This, in turn, pushes the cylinder 5, along with the elongated member 4 and the compressing member 1 to the rear of the security device 100.

When the compressing element 1 is pulled towards the rear of the security device 100, it compresses the compressible engagement member 2, which is in the form of an elastic ring, so that it bulges outward. The pins 11, 12 attached to the compressing element 1 keep the compressing element 1, the compressible member 2, and spacer 3 from rotating with the lock cylinder 5. The compressed engagement member 2 prevents the security device from being separated from the article to which it is attached. The lock cylinder 5 may be coupled to the lock housing 6 (attachment not shown).

Advantageously, if a thief tries to grab the housing 6 and apply a torque to it, this will cause the elongated member 5 to rotate relative to the compressing element 1, the compressible member 2, and the spacer 3. The elongated member 5 will “float” with respect to these components. The thief is therefore unable to remove the security device 100 from an article to be secured by turning the housing 6 and applying a torque to the housing 6. In addition to providing security advantages, the security device 100 described above has a simple design and is easy to manufacture and operate.

Alternative designs can be used in other embodiments of the invention. For example, instead of using a compressible engagement member to engage a security aperture in a housing of an article to be secured, it is possible to have a non-compressible engagement member. For example, the compressible engagement member 2 shown in FIGS. 1-3 can be replaced with an engagement member including two rigid wings that may extend radially outward in a locked position and may be retracted radially inward in an unlocked position. A hole in the engagement member can permit the passage of an elongated member such as the elongated member 4 shown in FIGS. 1-3. Like the previously described embodiments, the elongated member 4 and the housing 6 that is coupled to the elongated member can be allowed to “float” with respect to the engagement member. This prevents a potential thief from turning the housing 6 and applying a torque to the security device 100. The security device 100 cannot be separated from the article to be secured by turning the housing 6 of the security device 100.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None is admitted to be prior art.

What is claimed is:

1. A security device for use with a security aperture, the security device comprising:
an engagement member capable of being in a locked position or an unlocked position;
a spacer adjacent to the engagement member;
a locking mechanism adapted to maintain the locked position of the engagement member; and
a housing disposed around the locking mechanism,
wherein the housing is adapted to rotate substantially independently of the spacer when the engagement member is in the locked position.

2. The security device of claim 1 wherein the engagement member is compressible.

3. The security device of claim 1 wherein the engagement member is compressible, and wherein the security device further includes a compressing element adapted to compress the compressible engagement member.

4. The security device of claim 1 wherein the security device is a portable electronic device.

5. The security device of claim 1 further comprising an elongated member which passes through the engagement member and rotates independently of the engagement member.

6. A security system comprising:
the security device of claim 1, wherein the security system comprises an article including the security aperture.

7. The security system of claim 6 wherein the article is a portable electronic device.

8. A method of using the security device of claim 1 comprising:
obtaining an article comprising the security aperture;
inserting the engagement member into the security aperture; and
securing the article to an immovable object using the security device.

9. The method of claim 8 wherein the article is a portable electronic device.

10. The method of claim 8 wherein the security aperture is a security slot having dimensions of about 3 mm by about 7 mm.

11. A security device for use with a security aperture, the security device comprising:
a compressing element capable of being in a locked position and an unlocked position;
a compressible engagement member; and
a locking mechanism adapted to maintain the locked position of the compressing element,
wherein the compressible engagement member is compressed by the compressing element when the compressing element is in the locked position, and wherein the compressed compressible engagement member prevents removal of the compressible engagement member from the security aperture.

12. The security device of claim 11 wherein the security aperture is a security slot, wherein the security device further includes a security body, and wherein the security body comprises a cable.

13. The security device of claim 11 wherein the compressible engagement member is an elastic ring.

14. The security device of claim 11 wherein the security aperture is a security slot having dimensions of about 3 mm×about 7 mm.

15. The security device of claim 11 wherein the security aperture is in a housing of an electronic device.

16. The security device of claim 11 wherein the locking mechanism comprises a key lock.

17. The security device of claim 11 further comprising a cylinder coupled to the compressing element, wherein the cylinder is adapted to turn around an axis of the cylinder.

18. The security device of claim 11 further comprising a pin, and a cylinder coupled to the compressing element, wherein the cylinder is adapted to turn around an axis of the cylinder, and wherein the cylinder has at least one groove which receives the pin and which is in the form of a spiral around the cylinder.

19. The security device of claim 11 further comprising a pin, and a cylinder coupled to the compressing element, wherein the cylinder is adapted to turn around an axis of the cylinder, wherein the cylinder has at least one groove which receives the pin and which is in the form of a spiral around the cylinder, wherein the security device further comprises elongated member, and wherein the elongated member couples the compressing element and the cylinder.

20. The security device of claim 11 further comprising a pin, and a cylinder coupled to the compressing element, wherein the cylinder is adapted to turn around an axis of the cylinder, wherein the cylinder has at least one groove which receives the pin and which is in the form of a spiral around the cylinder, wherein the security device further comprises an elongated member, and wherein the elongated member couples the compressing element and the cylinder.

21. The security device of claim 11 further comprising a pin, and a cylinder coupled to the compressing element, wherein the cylinder is adapted to turn around an axis of the cylinder, and wherein the cylinder has at least one groove which receives the pin and which is in the form of a spiral around the cylinder, wherein the security device further comprises an elongated member, wherein the elongated member couples the compressing element and the cylinder, and wherein the security device further comprises a housing disposed around the cylinder.

22. A security system comprising:
an article comprising a security aperture; and
a security device for use with a security aperture, the security device comprising a compressing element capable of being in a locked position and an unlocked position, a compressible engagement member, and a locking mechanism adapted to maintain the locked position of the compressing element, wherein the compressible engagement member is compressed by the compressing element when the compressing element is in the locked position, and wherein the compressed compressible engagement member prevents removal of the compressible engagement member from the security aperture.

23. The system of claim 22 wherein the security aperture is a security slot.

24. The system of claim 22 wherein the compressible engagement member is an elastic ring.

25. The system of claim 22 wherein the security aperture is a security slot having dimensions of about 3 mm×about 7 mm.

26. The system of claim 22 wherein the security aperture is in a housing of an electronic device, and wherein the article is an electronic device.

27. The system of claim 22 wherein the locking mechanism comprises a key lock.

28. A method for securing an article, the method comprising:
obtaining an article comprising a security aperture;
inserting a compressing element and a compressible engagement member in a security device into the security aperture;
compressing the compressing member with the compressing element; and
maintaining a locked state of the compressing element.

29. The method of claim 28 wherein the security aperture is a security slot.

30. The method of claim 28 wherein the compressible engagement member is an elastic ring.
